(19) United States
(12) Patent Application Publication
(10) Pub. No.: US 2010/0064256 A1
(43) Pub. Date: Mar. 11, 2010

(54) Information Processing System

(75) Inventor: Yasuhiro Esaki, Inashiki-gun (JP)

Correspondence Address: THE NATH LAW GROUP, 112 South West Street, Alexandria, VA, 22314, US

(73) Assignee: RISO KAGAKU CORPORATION, Tokyo (JP)

(21) Appl. No.: 12/585,139

(22) Filed: Sep. 4, 2009

(30) Foreign Application Priority Data
Sep. 5, 2008 (JP) P2008-229043

(51) Int. Cl. G06F 3/048; H04L 9/32; G06F 21/00

(52) U.S. Cl. 715/825; 726/7

(57) ABSTRACT

A menu controller responds to a general user's login, by displaying a general user oriented menu frame including menu items accessible for selection by a general user, to a managing user's login, by displaying a manager oriented normal menu frame including in an initial state thereof a combination of menu items accessible for selection by a general user, and a menu item accessible for selection for reconfirmation of the managing user's login, and to a selection of the menu item for reconfirmation, by displaying menu items accessible for selection by a managing user.

### BACKGROUND OF THE INVENTION

1. Field of the Invention

The present invention relates to an information processing system, and particularly, to an information processing system adapted for an authenticated login to identify the user as a general user or managing user.

2. Description of Related Art

In the art of information processing systems such as printing machines or personal computers, there has been a prevailing user management requesting any user to undergo an authenticated login for identification. In the user management, as having been disclosed in Japanese Patent Application Laid-Open Publication No. 2006-172183, users of an information processing system have been classified into a group of general users and a group of managing users, having accessible setting items designated by the group. Any user in the group of general users (collectively referred herein to “a general user”) has been permitted to access those setting items which have their sub-item conditions preset, as necessary, to make use of (e.g., printing, copying, and scanning) functions for a specific application of the information processing system. The general user has been authorized to select any of those operations to which necessary control actions have been programmed in accordance with the preset sub-item conditions. Any user in the group of managing users (collectively referred herein to “a managing user”) has also been permitted to access any setting item for general users, and authorized to select any operation programmed for general users. The managing user has been further permitted to access any of designated manager setting items, for changing one or more sub-item conditions thereof to program control actions for another operation. The manager setting items have been items of user information setting, network setting, application setting, hardware setting, system setting, and the like.

### SUMMARY OF THE INVENTION

For any managing user having an authority to perform a manager setting, the information processing system displayed a setting frame for the manager setting after login of the managing user. However, the managing user was not always a user wanting the manger setting, and usually was a user desiring a combination of average operations including: an access to any setting item for general users; and a selection of any programmed operation for general users. Under such the situation, displaying the setting frame for the manager setting would not simply constitute a redundancy in frame configuration, but also cause the managing user to hold concerns about a possible change of sub-item condition in an item of the manager setting, so the managing user might be forced to sense an undue tense in average operations, as an issue.

The present invention has been devised in view of such an issue, and it is an object of the present invention to provide an information processing system adapted for a reduced redundancy in flame configuration, allowing for managing users to be free of undue tenses in their average operations.

To achieve the object, according to an aspect of the present invention, an information processing system is adapted for an authenticated login of any user to identify the user, the system comprising a user information manager configured for management to determine after a login of any user whether the user is a general user or a managing user, and a menu controller configured for control to display a subset of a set of menu items each accessible for selection by the general user or the managing user, whichever is permitted, to input a corresponding operational instruction, wherein the menu controller is adapted as a user having logged in is determined as being the general user, to display a general user oriented menu frame comprising a first subset of the set of menu items selective by the general user, as a user having logged in is determined as being the managing user, to display a manager oriented normal menu frame comprising the first subset of the set of menu items, and a menu item selective for confirmation of a managing user's login, and as the menu item for confirmation is selected, to display a second subset of the set of menu items selective by the managing user.

### BRIEF DESCRIPTION OF DRAWINGS

FIG. 1 is an illustration of configuration of a networked printing system according to an embodiment of the present invention.

FIG. 2 is a functional block diagram of a printing machine and a PC (personal computer) in the networked printing system.

FIG. 3 is a functional block diagram of a setting manager of the printing machine.

FIG. 4 is an illustration of configuration of a user information managing table of the setting manager.

FIG. 5 is a flowchart of control actions in a login process of the printing machine.

FIG. 6 is an illustration of a waiting flame displayed on an operation panel of the printing machine.

FIG. 7 is an illustration of a user selection frame displayed on the operation panel.

FIG. 8 is an illustration of a password input frame displayed on the operation panel.

FIG. 9 is an illustration of a general user oriented login flame displayed on the operation panel for a login of general user.

FIG. 10 is an illustration of a manager oriented normal login flame displayed on the operation panel for a normal login of manager.

FIG. 11 is an illustration of a manager oriented managing login frame displayed on the operation panel for a managing login of manager.

FIG. 12 is an illustration of a manager oriented setting frame displayed on the operation panel.

FIG. 13 is an illustration of a login setting flame displayed on the operation panel.

FIG. 14 is an illustration of a user setting frame displayed on the operation panel.

FIG. 15 is an illustration of a condition change flame displayed on the operation panel.

FIG. 16 is an illustration of a maintenance operation changeover frame displayed on the operation panel.

FIG. 17 is a flowchart of control actions in a maintenance service by maintenance personnel.

FIG. 18 is an illustration of a confirmation flame displayed on the operation panel.

FIG. 19 is an illustration of a maintenance personnel test mode frame in a test mode for permission to initialization by maintenance personnel.

FIG. 20 is an illustration of a maintenance personnel test mode flame in a test mode for prohibition to initialization by maintenance personnel.

FIG. 21 is an illustration of another maintenance operation changeover flame.

### DETAILED DESCRIPTION OF PREFERRED EMBODIMENT

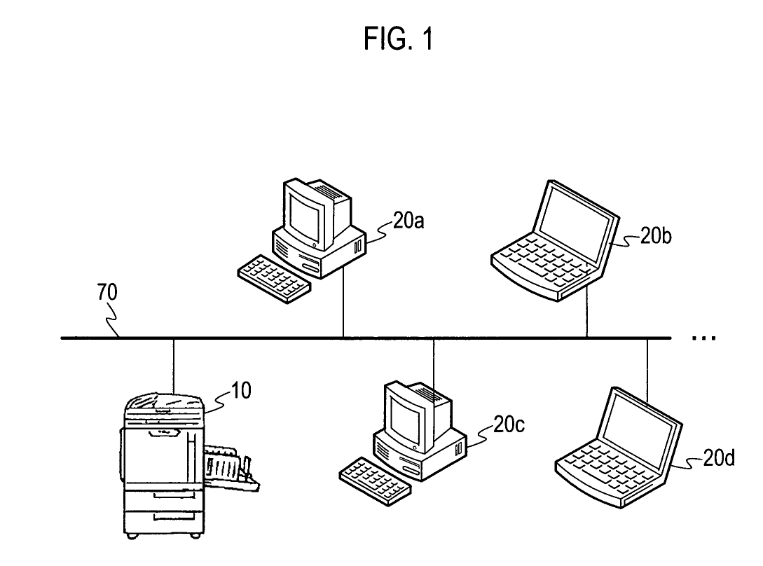

There will be described an embodiment of the present invention, with reference to the accompanying drawings. In this embodiment, the present invention is implemented as an information processing system applied to a printing machine. FIG. 1 is an illustration of configuration of a networked printing system according to the present embodiment. As illustrated in the figure, the networked printing system is configured with a printing machine 10 and personal computers 20a, 20b, 20c, 20d, . . . (referred herein collectively to PC 20) each respectively connected to a computer network 70. It is noted that the information processing system according to the present invention is not limited to a networked printing system, and may well be a stand-alone printing system including a printing machine 10 and local PC 20 directly connected thereto, or a single-machine system composed of a printing machine 10.

The printing machine 10 has a printer function for a printing based on a print data sent from any PC 20, a scanner function for scanning an image of an original sheet on a platen to send a scanned image to any PC 20, and a copier function for a duplicate printing of a scanned image.

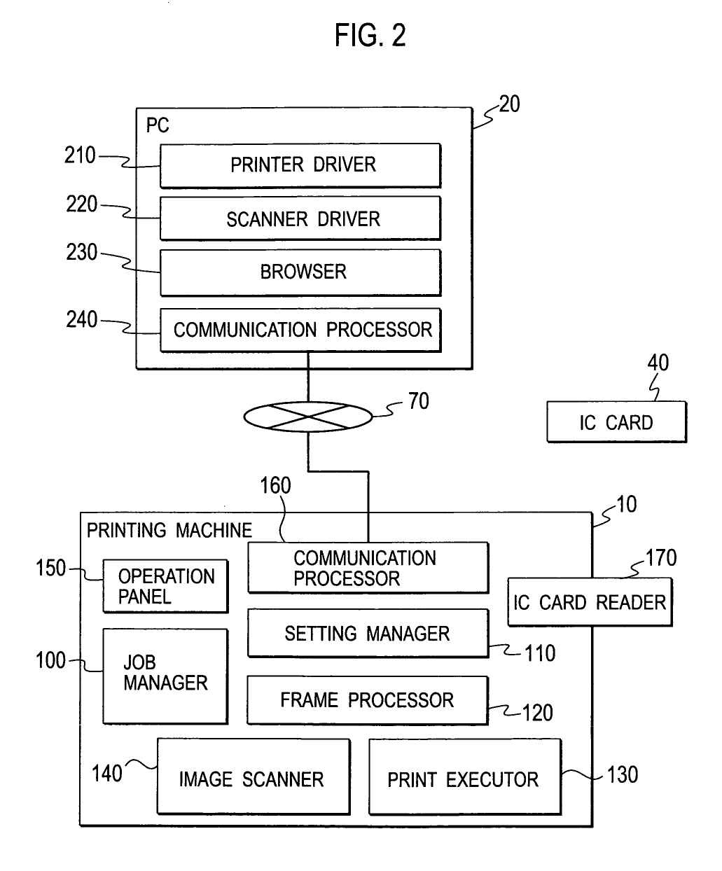

FIG. 2 is a functional block diagram of the printing machine 10 and a PC 20 in the networked printing system. As illustrated in the figure, the printing machine 10 includes a job manager 100, a setting manager 110, a frame processor 120, a print executor 130, an image scanner 140, an operation panel 150, a communication processor 160, and an IC (integrated circuit) card reader 170. The setting manager 110 and the flame processor 120 may be each built as a functional module on a controller substrate that may have, for instance, a CPU (central processing unit), memories, and an image processing device installed thereon.

The job manager 100 is configured to manage print jobs that the printing machine 10 has received. The management of print jobs includes, for instance, controlling the order of print jobs to be executed, and coping with errors. The job manager 100 is configured with a hard disc device or the like for provision of a storage area to store therein print data of print jobs associated with users. Print data in the storage area may include, for instance, those print data stored therein by instructions received from users, and a preset amount of last received print data.

The setting manager 110 is configured as a functional element for managing various settings concerning the printing machine 10, and various settings concerning users of the printing machine 10. The setting manager 110 is adapted to accept such the settings through a setting frame displayed on the display panel 150. Further, it is adapted to output the setting frame as a web page, and accept through a later-described browser 230 of PC 20. The settings to be accepted by the setting manager 110 will be detailed later on.

The frame processor 120 is configured for processing a frame of print data sent from any PC 20 as well as a frame of image data scanned by the image scanner 140. The frame processing to be executed by the frame processor 120 includes, for instance, processing print data to spread, processing image data for color conversion, binarization, and gradation, and the like.

The print executor 130 has a printing mechanism using an image forming medium for formation of an image on a printing sheet to thereby implement a printing action. In this embodiment, it employs an inkjet printing mechanism using an ink as the image forming medium, to execute a printing by propelling ink droplets by lines from a printing head with a width covering a printing sheet. It may employ a serial type inkjet printing mechanism, or alternatively an electro-photographic printing mechanism using a toner as the image forming medium to execute a printing by deposition of toner on a sheet. Further, the print executor 130 has a sheet feed mechanism and a sheet transfer mechanism.

The image scanner 140 has a light source, a lens system, a platen, an array of light receiving elements, a scanning mechanism, and the like, whereby it is adapted to scan an image of an original sheet put on the platen, convert scanned data into electric signals, and output them to the frame processor 120. The image scanner 140 may be incorporated in a housing of the printing machine 10, or installed alone outside the housing of printing machine 10.

The operation panel 150 is configured for, among others, displaying e.g. an operation menu and contents of a setting of the printing machine 10, and accepting an instruction from user through the operation menu. The operation panel 150 may be a touch-panel display, for instance.

The communication processor 160 is adapted for a protocol processing according to a connection mode to execute communications with PC 20 through the computer network 70. For instance, in a LAN (local area network) connection, it may execute a processing for TCP/IP (transmission control protocol/internet protocol) communications.

The IC card reader 170 is adapted to read stored information in an IC card 40. In this embodiment, the IC card 40 is configured for storing information on a user ID (identification) of a registered user, and the IC card reader 170 is configured for reading the IC card 40 to implement a user authentication. It is noted that the storage medium of user ID for user authentication is not limited to the IC card 40, and may be an available recording medium such as an USB (universal serial bus) memory or an RF (radio frequency) tag. In this case, the printing machine 10 should have a reader complying with the recording medium.

As shown in FIG. 2, each PC 20 has a printer driver 210, a scanner driver 220, a browser 230, and a communication processor 240. The PC 20 has an unshown operating system defining fundamental actions such as for user interface, file control, and user control. As usual, the operating system has a login function to identify any user of the PC 20 by a login ID.

There is a printer driver program developed in correspondence to the printing machine 10, which is executed by a CPU of the PC 20, whereby the printer driver 210 is formed. The printer driver 210 is configured for a process of producing a frame of print data such as of a document to be printed, in accordance with an instruction from a user, to output to the printing machine 10.

There is a scanner driver program developed in correspondence to the image scanner 140 of printing machine 10, which is executed by the CPU of PC 20, whereby the scanner driver 212 is formed. The scanner driver 220 is configured for a process of controlling an image scanning process of the printing machine 10 in accordance with an instruction from a user.

The browser 230 has a function of displaying a web page, and is adapted herein to display a setting frame and the like the setting manager 110 of printing machine 10 provides, while accepting an operation of user on the setting frame to output to the setting manager 110.

The communication processor 240 is adapted for a protocol processing according to a connection mode to execute communications with the printing machine 10 through the computer network 70. For instance, in a LAN connection, it may execute a processing for TCP/IP communications.

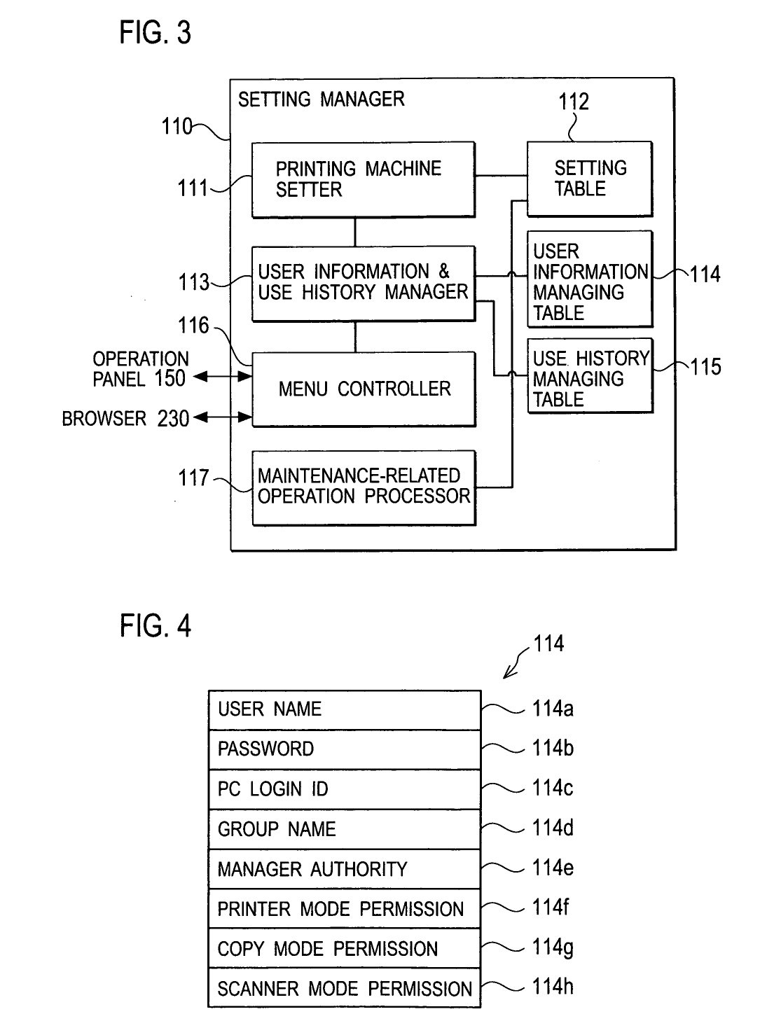

FIG. 3 is a functional block diagram of the setting manager 110 of printing machine 10. As illustrated in the figure, the setting manager 110 includes a printing machine setter 111, a setting table 112, a user information & use history manager 113, a user information managing table 114, a use history managing table 115, a menu controller 116, and a maintenance-related operation processor 117.

The printing machine setter 111 is configured for accepting, to store, various settings concerning the printing machine 10 from any managing user. The settings concerning the printing machine include, for instance, setting items of a networking setting, such as an IP address, and settings concerning options of functions. They include, for each of printer function, copier function, and scanner function, a setting of whether the use needs a login or a login-free use is permitted. Further, the printing machine setter 111 is configured to accept from a user a setting of whether an initialization of the printing machine 10 is permitted or prohibited in a later-described test mode by maintenance personnel.

The printing machine 10 is adapted to classify users into a group of general users and a group of managing users (each referred herein sometimes simply to a manager). Each managing user is permitted to access to any setting item concerning the printing machine 10. In this embodiment, any managing user is permitted to take one of two login conditions being a login as a manager, and a login as a general user. Under the condition of login as a manager, any managing user is permitted to access to any setting item concerning the printing machine 10, and perform processes such as for registration and change of user information, and job control, as will be described later on. Under the condition of login as a general user, the user is permitted to simply perform normal processes using the printer function, copier function and scanner function.

The user information & use history manager 113 is configured for accepting information on a user of the printing machine 10 from a manager under the condition of login as a managing user, to store in the user information managing table 114, while storing information on use history of the printing machine 10 in the use history managing table 115.

The user information managing table 114 is adapted to store, as illustrated in FIG. 4 for instance, a user name 114a, a password 114b, a PC login ID 114c, a group name of user 114d, a manager authority 114e, a printer mode permission 114f, a copy mode permission 114g, and a scanner mode permission 114h, for each user.

The password 114b is a piece of information for authentication at a login to operate the printing machine 10. The PC login ID 114c is a piece of information for authentication at a login to the printing machine 10 through any PC 20, and may be a user ID for use at a login to an operating of the PC 20. The group name of user 114d is a name of the group the user belongs to, as a category to control users by groups. The user information & use history manager 113 may be adapted for a control of group-related information using an unshown table. The manager authority 114e is a piece of information on whether the user is a managing user or not. The group of managing users may include one or more personnel.

The printer mode permission 114f, copy mode permission 114g, and scanner mode permission 114h are pieces of information on whether or not the user is permitted to use the printer function, copier function, and scanner function, respectively. That is, the printing machine 10 is adapted, for each user, to set up whether the user should be permitted or prohibited to use a respective one of printer function, copier function, and scanner function in an independent manner in between. Further, it may well be adapted for individual settings of particular authority items such as limitations of use to a color printing function, the number of printing sheets, and the like.

The use history managing table 115 is adapted to store the number of times of use by the function for each user, including, among others, the number of times of printing, the number of times of copying, the number of times of scanning, and a total number of times of use by function of the printing machine 10, for instance.

The menu controller 116 is configured for processes of controlling transition of any frame of setting menu displayed on the operation panel 150 or the browser 230, while accepting a variety of settings of any managing user after login as a manager.

The maintenance-related operation processor 117 is configured for a process of managing maintenance services of any maintenance personnel to be dispatched for inspection or maintenance from a manufacturer or maintenance company of the printing machine 10. More specifically, there are setting items provided for authentication of maintenance personnel, and execution of various modes of tests (maintenance inspections) for maintenance services. Test modes for maintenance services include a process of initializing the printing machine 10. The initializing process has a significant influence on users, so the initializing process by maintenance personnel is restricted in this embodiment. That is, any maintenance personnel is permitted to enter the initializing process, only when given a permission by any managing user of the printing machine 10. It is noted that such a restriction is not limited to the initializing process, as will be described later on.

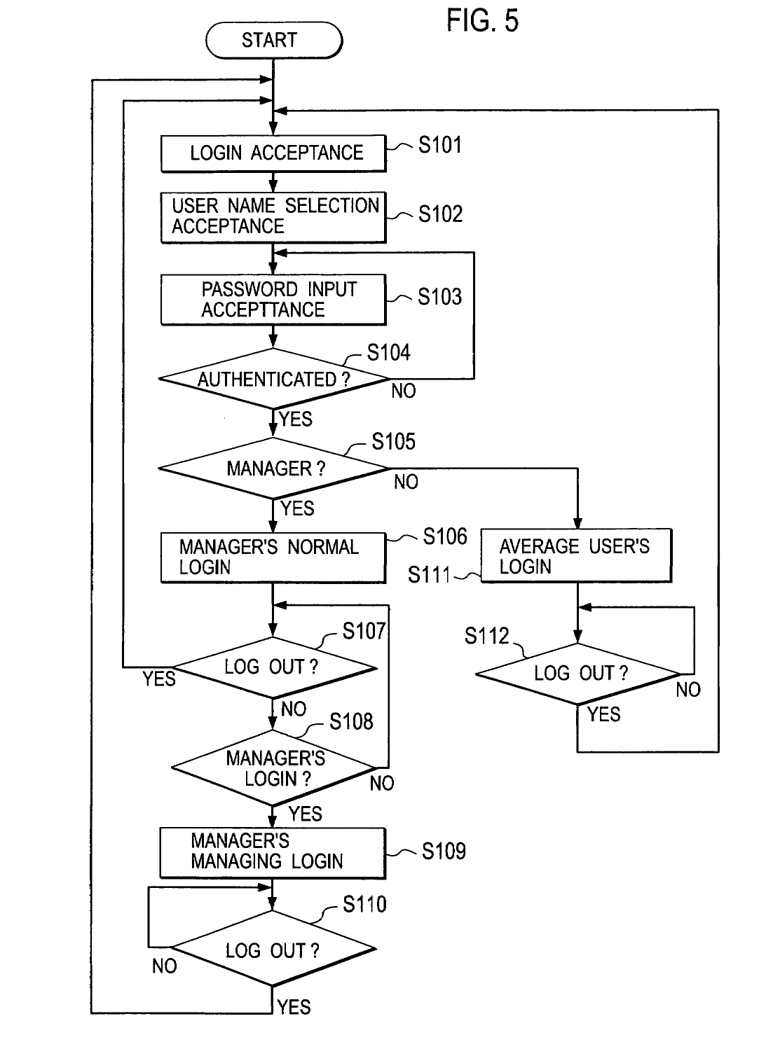

Description is now made of a login process of the printing machine 10, with reference to a flowchart of FIG. 5. There are several users assumed to have been registered by a managing user.

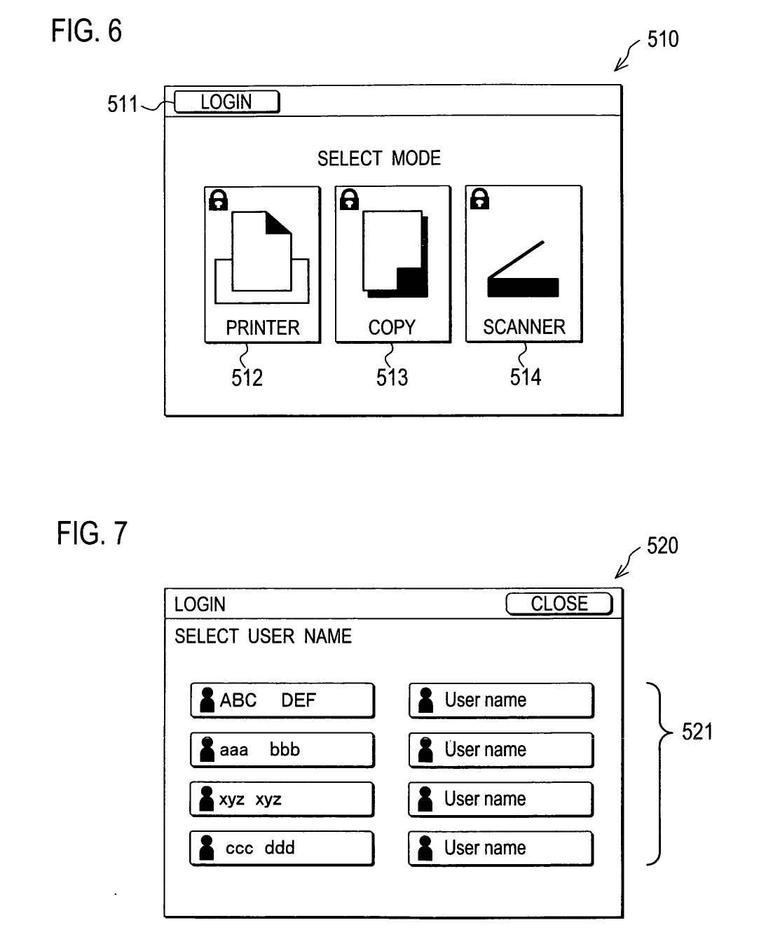

First the printing machine 10 is held in a waiting state, where, as illustrated in FIG. 6, the operation panel 150 has a waiting frame 510 displayed thereon. Also in access to the printing machine 10 using a browser 230 of any PC 20, the PC has a similar flame displayed on a display thereof.

The waiting frame 510 has a login button 511, a printer button 512, a copy button 513, and a scanner button 514 arranged therein. The printer button 512, copy button 513, and scanner button 514 are selective for use of the printer function, copier function, and scanner function, respectively. This example assumes a setting made on the printing machine setter 111 by the managing user, such that each of the function above should demand a login for use. Under any condition before login, the buttons are each labeled with a lock mark, indicating the effect of disabled use.

At a step S101, as the login button 511 in the frame is pressed, the control flow goes to a step S102, where as illustrated in FIG. 7, the operation panel 150 of printing machine 10 has a user select frame 520 displayed thereon. The user select flame 520 displayed has a list 521 of selective names of users registered in the user information managing table 114, while a user having pressed the login button 511 is allowed to press a button of own name of the user.

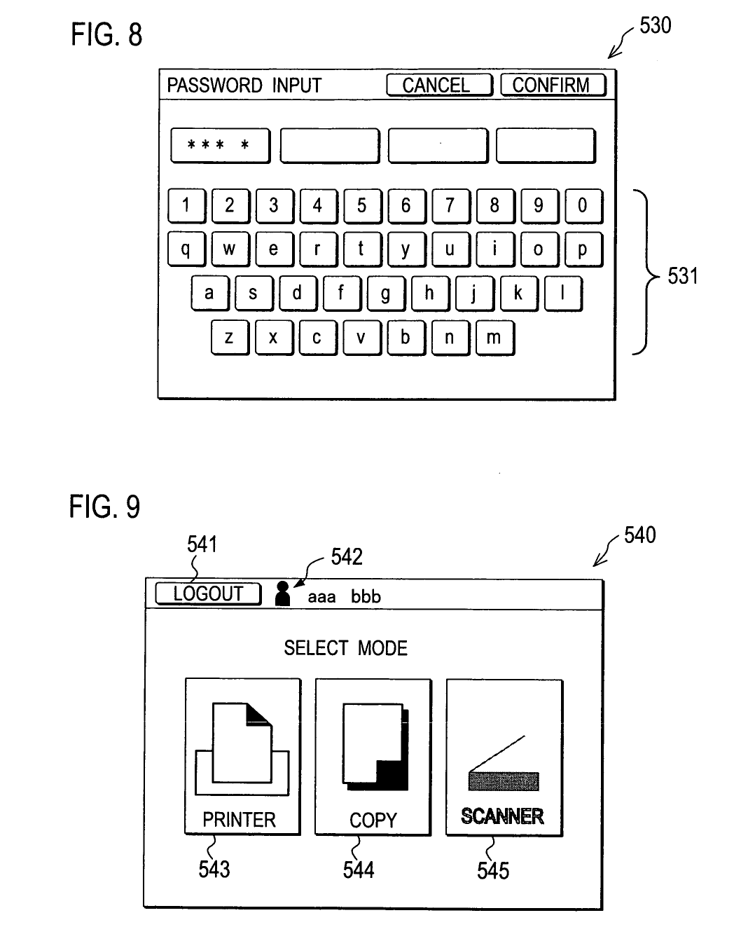

As a selection of user name is accepted, the flow goes to a step S103, where as illustrated in FIG. 8, the operation panel 150 of printing machine 10 has a password input frame 530 displayed thereon. The password input flame 530 displayed has a set of key buttons 531 permitting the user having pressed the login button 511 to input own password.

As an input of password is accepted, the flow goes to a step S104, where the input password is collated to passwords 114b stored in the user information managing table 114, whereby the printing machine 10 determines whether the user is authenticated or not. It is noted that for authentication of the user, the input of password may be substituted by use of an IC card 40 in which ID information of the user is recorded. In this case, the IC card 40 is held over an IC card reader 170, whereby the recorded information in the IC card 40 is read, allowing for an authentication. There may be a login made on a browser 230 of any PC 20. In this case, there may be an authentication performed by use of a login ID of the PC 20, such as by acquisition through an operating system thereof. In both cases, there is no need of inputting a password.

In failure of authentication (No at the step S104) due to an unmatched password, the flow goes to the step S103 to permit a retry of password input. On the other hand, for a authentication (Yes at the step S104) due to a matching password, the flow goes to a step S105, the user information managing table 114 is referred to, thereby acquiring a manager authority 114e of the authenticated user, for use to determine whether the authenticated user is a managing user or not.

Unless the user is a managing user (No at the step S105), the flow goes to a step S111 to permit the user to log in as a general user. FIG. 9 is an illustration of a general user oriented login frame 540 to be displayed on the operation panel 150 for a login of general user. The general user oriented login frame 540 has a logout button 541, an icon 542 representing a general user, a printer button 543, a copy button 544, and a scanner button 545 arranged therein. In this example, the general user is assumed as being permitted by a managing user to use the printer function and the copier function, but being prohibited to use the scanner function. Accordingly, the scanner button 545 is grayed out to indicate the disabled selection, while the general user is permitted to select one of the remaining functions in the general user oriented login frame 540, for execution of an associated process. After completion of the process, the logout button 541 can be pressed (Yes at a step S112) to log out, causing the flow go to the step S101 for the printing machine 10 to again display the waiting frame 510.

On the other hand, if the user is a managing user (Yes at the step S105), the flow goes to a step S106, where the printing machine 10 is put in a condition of manager normal login. Under the manager normal login condition, the managing user is unable to perform any operation item concerning manager setting, and is permitted to simply use the printer function, copier function, and scanner function like general users. As a result, there are secured preventions such as against having displayed a complex menu for manager setting that would be unnecessary for normal operations, and having carelessly changed a setting of the printing machine 10.

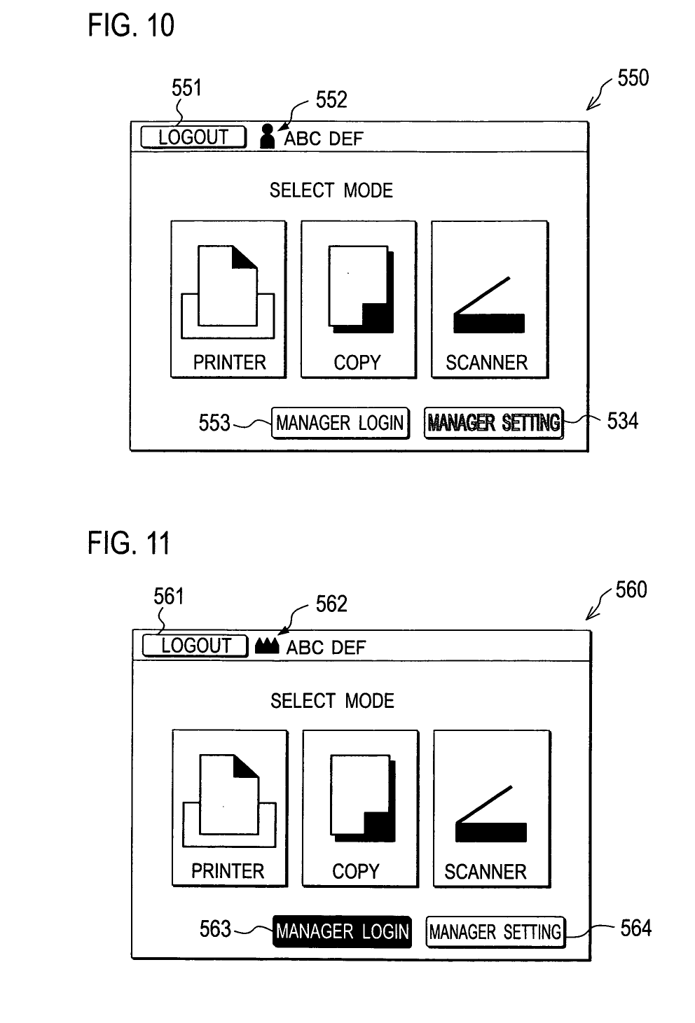

FIG. 10 is an illustration of a manager oriented normal login frame 550 displayed on the operation panel 150 under the condition of manager normal login. The manager oriented normal login frame 550 has a logout button 551, an icon 552 that is identical in shape to the icon 542 representing a general user to indicate it is not any login as a manager, a printer button, a copy button, a scanner button, a manager login button 553, and a manager setting button 554 arranged therein. For any normal operation to use the printer function, copier function, or scanner function, the user though being a managing user can do by simply selecting a function to be used in the manager oriented normal login flame 550 for execution of an associated process. After completion of the process, the logout button 551 can be pressed (Yes at a step S107) to log out, causing the flow go to the step S101 for the printing machine 10 to again display the waiting frame 510.

The manager login button 553 is a button to be pressed for login as a manager, and the manager setting button 534, a button to be pressed for a manager setting operation. Under the condition of manager normal login, the user though being a managing user is regarded as being a login as a general user unable to perform any manager setting operation, so the manager setting button 534 is grayed out for indication of a prohibited pressing.

In the manager oriented normal login frame 550, if the manager login button 553 is pressed (Yes at a step S108), the flow goes to a step S109, where the printing machine 10 is put in a condition of manager managing login that is a login as a manager. It is noted that for an increased security, the pressing of manager login button 553 may require an input of password as a manager for authentication as a manager. In this case, there may be a password separately preset for use by a manager and recorded in the user information managing table 114.

FIG. 11 is an illustration of a manager oriented managing login flame 560 displayed on the operation panel 150 under the condition of manager managing login. The manager oriented managing login flame 560 has a logout button 561, an icon 562 that is different in shape from the icon 542 representing a general user to indicate it is a login as a manager, a printer button, a copy button, a scanner button, a manager login button 563, and a manager setting button 564 arranged therein. The manager login button 563 is highlighted to indicate a login as a manager. The manager setting button 564 is permitted to press, as the current condition is a login as a manager that permits a manager setting operation.

The managing user having logged in as a manager can press the manager setting button 564 to enable a variety of manager setting operations. It will also be enabled to have an access to the job manager 100, such as for display or deletion of a job for general users. After completion of manager setting operation, the logout button 561 can be pressed (Yes at a step S110) to log out, causing the flow go to the step S101 for the printing machine 10 to again display the waiting flame 510. Or, the manager login button 563 may be again pressed to cancel the condition of login as a manager, to again go to the step S106 to enter the condition of manager normal login.

As will be seen from the foregoing description, according to the present embodiment, the login state of a managing user is categorized to distinguish between a login state as a manager and a login state as a general user, for provision of an initial state of login in which it is set as being a login state as a general user that is unable to perform any manager setting operation. As a result, the managing user can be kept from facing a displayed menu that would be unnecessary for normal operations, and prevented from performing unnecessary manager setting operations.

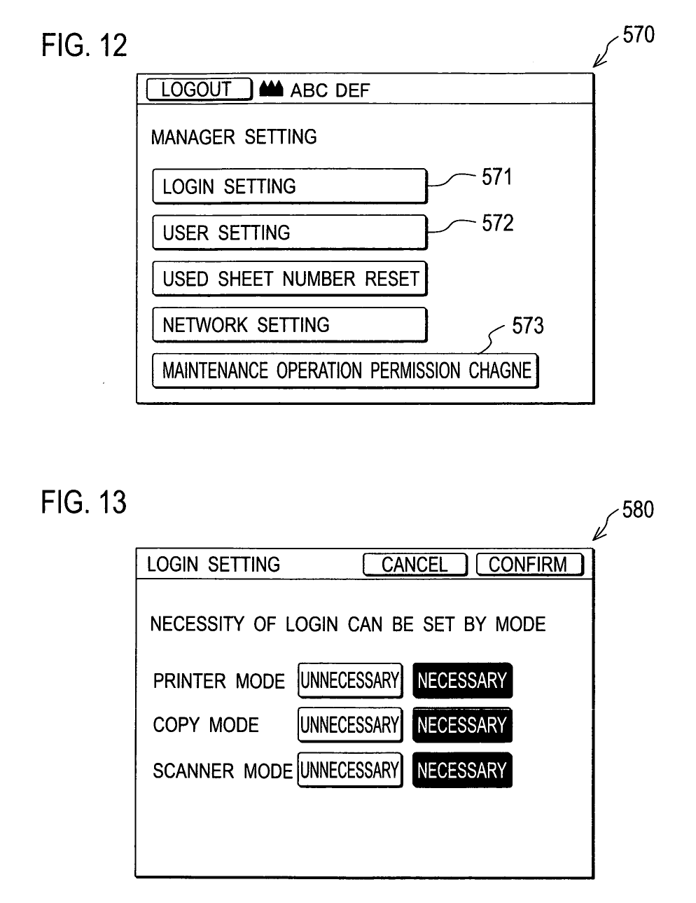

Description is now made of manager setting operations for the managing user to perform under the condition of manager managing login. In the manager oriented managing login frame 560 shown in FIG. 11, if the manager setting button 564 is pressed, then as illustrated in FIG. 12, the operation panel 150 of printing machine 10 has a manager oriented setting frame 570 displayed thereon.

The manager oriented setting flame 570 has a login setting button 571, a user setting button 572, a used sheet number reset button, a network setting button, and a maintenance operation permission change button 573 arranged therein.

The login setting button 571 is a button to set whether or not a login process is necessary for using each of printer function, copier function, and scanner function. If the login setting button 571 is pressed, then as illustrated in FIG. 13, the operation panel 150 of printing machine 10 has a login setting frame 580 displayed thereon. The login setting frame 580 is adapted for an arbitrary setting of whether or not a login is necessary for each of printer function, copier function, and scanner function. The managing user having logged in as a manager can do with a setting on the printer function for instance, by setting an “unnecessary” to permit unspecified users to use it without needing any login operation, or by setting a “necessary” to permit a use subject to a user authentication.

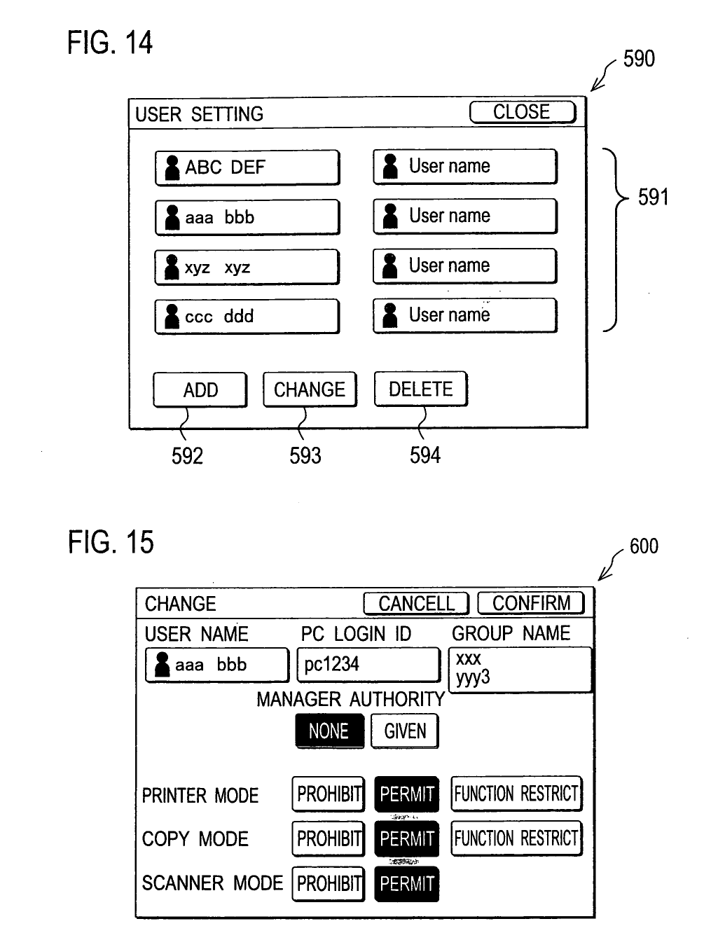

In the manager oriented setting frame 570, the user setting button 572 is a button for a managing user to make a user-related setting. If the user setting button 572 is pressed, then as illustrate in FIG. 14, the operation panel 150 of printing machine 10 has a user setting frame 590 displayed thereon. The user setting frame 590 displayed has a list 521 of selective names of users registered in the user information managing table 114, and besides, has an addition button 592, a change button 593, and a deletion button 594 arranged therein. The managing user having logged in as a manager can do with a change of information on a registered user for instance, by selecting the target user in a list 591 of users before pressing the change button 593.

If the change button 593 is pressed, then as illustrated in FIG. 15, the operation panel 150 of printing machine 10 has a change frame 600 displayed thereon. The change frame 600 displays thereon user information of a selected user recorded in the user information managing table 114. The managing user having logged in as a manager can change information of any user on the change frame 600. Changed user information is reflected on the user information managing table 114.

In the manager oriented setting frame 570, the maintenance operation permission change button 573 is a button for setting whether or not maintenance personnel of the printing machine 10 is to be given a permission of a prescribed operation. The maintenance personnel of printing machine 10 is assumed as personnel dispatched from a manufacturer or maintenance company of the printing machine 10, for inspection or maintenance services of the printing machine 10. Usually, the maintenance personnel give preset particular operations to shift the printing machine 10 in a test mode as necessary for various maintenance and inspection processes. Such the maintenance and inspection processes require permissions to various operations including an initialing process of the printing machine 10. Therefore, maintenance personnel may carelessly or intentionally initialize the printing machine 10. In this regard, the initializing process may be required for certain conditions of the printing machine 10, but is unnecessary for usual maintenance and inspection processes. The printing machine 10 has user information, network information, and the like. If initialized once, such information must be established from the first, in addition to that data on history of use get unavailable to refer. Still less, accumulated print data will be lost by initialization, and will not be restored.

To this point, in the present embodiment, any managing user is allowed to set a prohibition to the initializing process by maintenance personnel. It is noted that the extent of process to be prohibited is not limited to the initialization, and may cover any process else, or may be restricted to a sub-process. For instance, as additional items to be restricted, there may be an access to or change of user information, initialization of network setting, deletion of accumulated print data, and the like.

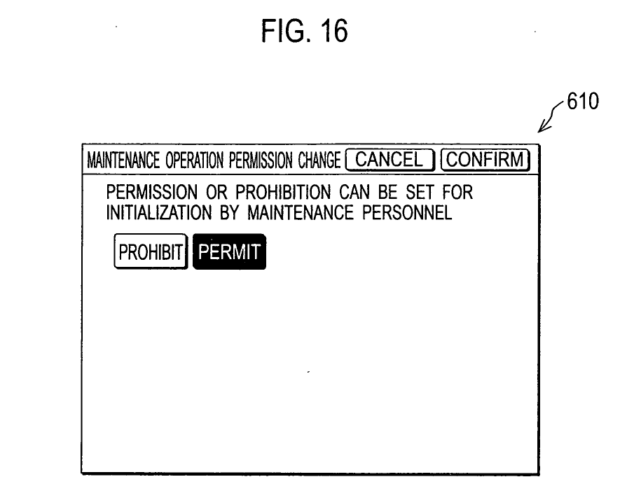

In the manager oriented setting frame 570, if the maintenance operation permission change button 573 is pressed, then as illustrated in FIG. 16, the operation panel 150 of printing machine 10 has a maintenance operation permission change frame 610 displayed thereon. The maintenance operation permission change frame 610 is adapted to set either a “permission” or a “prohibition” as to whether or not maintenance personnel should be given a permission of the initializing process. The managing user having logged in as a manager can do with setting the prohibition for prohibiting the initializing process by maintenance personnel, or with setting the permission for permitting the initializing process. For a safety purpose, preferably, there should be set a “prohibition” in an initial stage. There may well be a validity period or a validity number of times provided in consideration of a possible situation such as that a managing user having a “permission” set up has occasionally forgotten returning to a “prohibition”. For instance, there may be a presetting such as for a “permission” to be valid on day of a setting by a managing user, for an ensured return to a “prohibition” after a maintenance operation once performed, or for an ensured return to a “prohibition” as the printing machine 10 is powered off. Contents of the presetting may be recorded in the setting table 112.

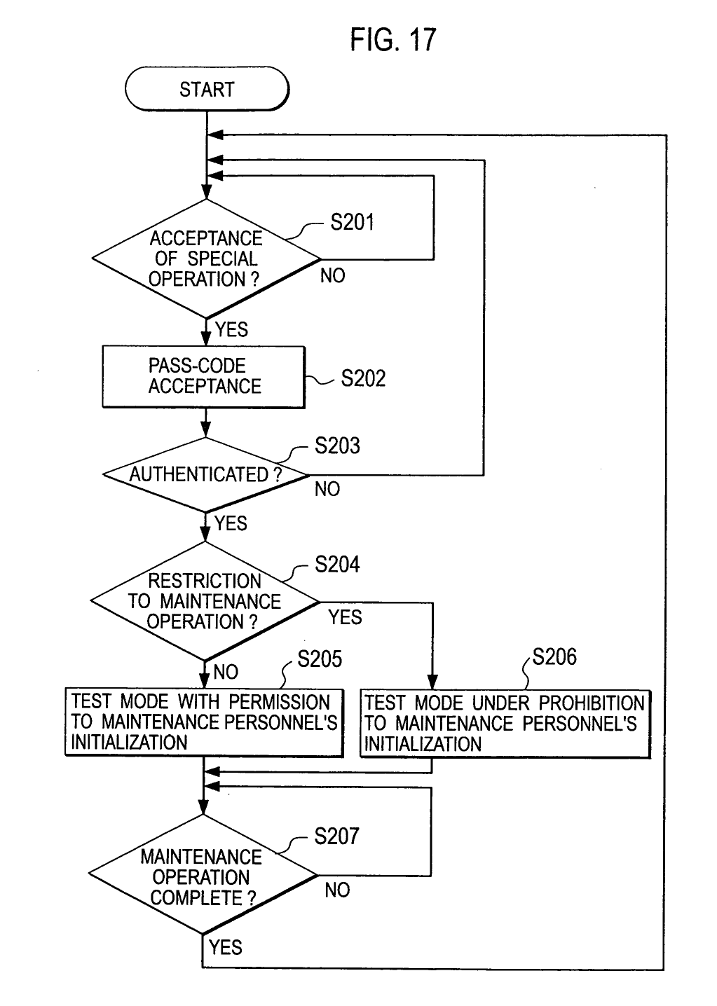

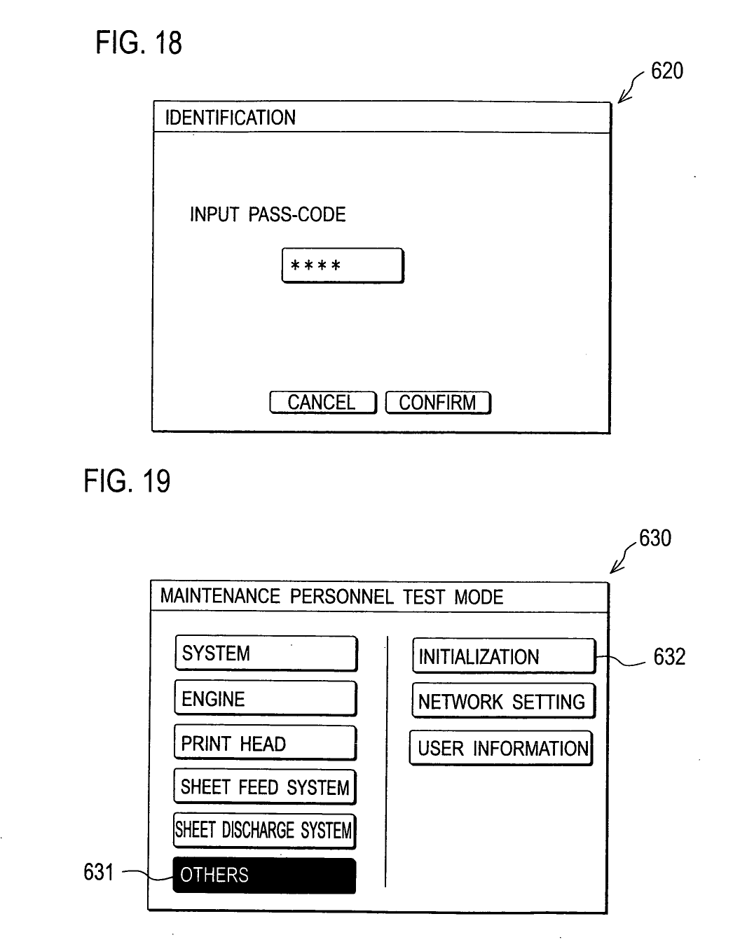

Description is now made of a flow of control actions in a maintenance service by maintenance personnel, with reference to a flowchart in FIG. 17. There are special operations preset for shifting the printing machine 10 into test modes for maintenance services. There may be a special operation as a prescribed key operation on the operation panel 150, combined with a pass-code to be input. Such the key operation and pass-code are assumed to have been factory-set, and informed simply to maintenance personnel and factory-related personnel, while unknown to any managing user. There may be a set of different codes such as a pass-code for maintenance personnel, a pass-code for production division, and a pass-code for development division, allowing for different contents of test modes to be implemented by worker.

At the printing machine 10, as a preset special operation is accepted (Yes at a step S201), the control flow goes to a step S202 for acceptance of an input pass-code. For a maintenance personnel authenticated by the pass-code (Yes at a step S203), the flow goes to a step S204, where the setting table 112 is retrieved for reference to the content of a recorded setting for permission to maintenance services, checking for a restriction to a maintenance operation, that is, whether an initialization is prohibited or permitted.

As a result, if the setting is a permission to the initialization (No at the step S204), the flow goes to a step S205 for a shifting to a test mode in which the initialization by the maintenance personnel is permitted. FIG. 19 is an illustration of a maintenance personnel test mode frame 630 in the test mode where the initialization by maintenance personnel is permitted. The maintenance personnel test mode frame 630 has an array of switch buttons displayed in the left column for an arbitrary selection among categories of maintenance services, and another array of switch buttons displayed in the right column for an arbitrary selection among specific maintenance operations associated with a selection at the left column. This frame includes an “others” button 631 covering any category of available maintenance services else, of which a list of maintenance operations will be displayed when that button is selected. The category “others” covers an initialization button 632 to be selected for a return to a factory-set or free-at-factory condition. The initialization button 632 is displayed to be accessible for selection in the test mode in which the initialization by the maintenance personnel is permitted.

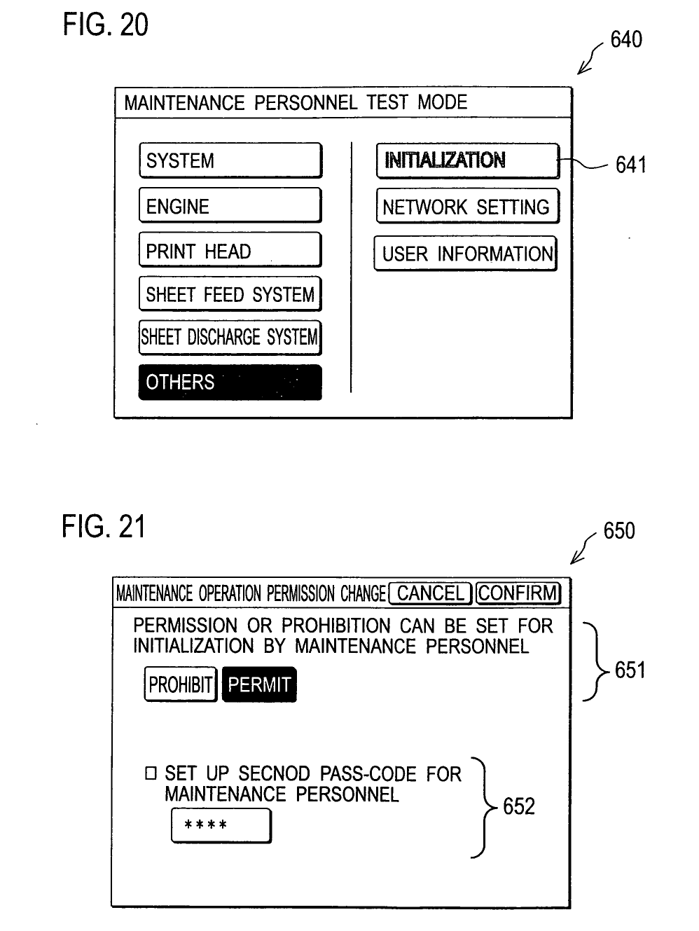

On the other hand, if the setting is a prohibition to the initialization (Yes at the step S204), the flow goes to a step S206 for a shifting to a test mode in which the initialization by the maintenance personnel is prohibited. FIG. 20 is an illustration of a maintenance personnel test mode frame 640 in the test mode where the initialization by maintenance personnel is prohibited. The test mode flame 640 has an initialization button 641 grayed out to be inaccessible for selection.

For an increased safety, there may be a second pass-code set up by a managing user for authentication of maintenance personnel, besides a factory-set pass-code. The second pass-code may be set by a managing user, for instance, as illustrated in FIG. 21, in a maintenance service permission change frame 650, to a maintenance personnel oriented second pass-code setting region 652 provided therein. The second pass-code setting region 652 may include, for instance, a combination of a sub-region for designation of whether a second pass-code is to be set or not, and another sub-region for setting the second pass-code.

Given a second pass-code set up by a managing user, the maintenance personnel has to input the second pass-code, besides a preset pass-code, before shifting the printing machine 10 into a test mode. This means a required notification of the second pass-code from the managing user to the maintenance personnel. Accordingly, any maintenance personnel having performed a maintenance service in a test mode should have been qualified maintenance personnel as ensured by the first pass-code authentication, and permitted by a managing user to perform the maintenance service as ensured by the second pass-code authentication.

There may well be a validity period or a validity number of times provided for the second pass-code. For instance, there may be a presetting such as for a permission to be valid on day of a setting by a managing user, for an ensured invalidation after a shifting once made to a test mode, or for an ensured invalidation as the printing machine 10 is powered off. It will allow for the more enhanced security.

As will be seen from the foregoing description, according to the present embodiment an information processing system is configured to display, in an initial stage after a managing user's login, a manager oriented normal menu frame including a combination of a general user oriented menu, and a menu item added thereto and accessible for selection to accept a login as a managing user. And, the flame displayed to the managing user is simplified in configuration, eliminating anxieties about a careless change of the content of manager setting. This allows for an improved operational feeling in normal operation of managing user. It is noted that the menu item for acceptance of a manager's login may well be a manager oriented login button, for instance. Further, the manager oriented setting may cover items of a user information setting, a network setting, and the like.

While the preferred embodiments of the present invention have been described using specified terms, such description is for illustrative purposes, and it is to be understood that changes and variations may be made without departing from the spirit or scope of the following claims.

This application is based upon the Japanese Patent Application No. 2008-229043, filed on Sep. 5, 2008, the entire content of which is incorporated by reference herein.

What is claimed is:

1. An information processing system adapted for an authenticated login of any user to identify the user, the system comprising:
a user information manager configured for management to determine after a login of any user whether the user is a general user or a managing user, and
a menu controller configured for control to display a subset of a set of menu items each accessible for selection by the general user or the managing user, whichever is permitted, to input a corresponding operational instruction, wherein
the menu controller is adapted:
as a user having logged in is determined as being the general user, to display a general user oriented menu frame comprising a first subset of the set of menu items selective by the general user;
as a user having logged in is determined as being the managing user, to display a manager oriented normal menu flame comprising the first subset of the set of menu items, and a menu item selective for confirmation of a managing user's login; and
as the menu item for confirmation is selected, to display a second subset of the set of menu items selective by the managing user.

2. The information processing system according to claim 1, wherein the menu controller is adapted to display the second subset of the set of menu items after confirmation of the managing user's login by the user information manager.

3. The information processing system according to claim 1, wherein the menu controller is adapted to display one of the general user oriented menu flame with a first icon indicating a general user's login, the manager oriented normal menu frame with a second icon identical in shape to the first icon, and a manager oriented managing menu flame including the second subset of the set of menu items, with a third icon indicating a managing user's login and different in shape from the first icon.

4. The information processing system according to claim 1, wherein the manager oriented normal menu frame has the second subset of the set of menu items displayed therein in a manner inaccessible for selection.

5. The information processing system according to claim 1, wherein the second subset of the set of menu items includes a menu item selective for one of a user information setting and a network setting.
